(19) United States
(12) Patent Application Publication
(10) Pub. No.: US 2005/0085365 A1
(43) Pub. Date: Apr. 21, 2005

(54) Pre-folded and pre-glued flower wrap sheets and methods for making

(76) Inventor: Steven Tchira, Miami, FL (US)

Correspondence Address: GEORGE A WILLINGHAN III;ATTORNEY-AT-LAW, SUITE 350, 3201 NEW MEXICO AVENUE, NW, WASHINGTON, DC, 20016, US

(21) Appl. No.: 10/743,977

(22) Filed: Dec. 23, 2003

Related U.S. Application Data
(63) Continuation-in-part of application No. 10/687,337, filed on Oct. 16, 2003.

(51) Int. Cl. B31B 1/26

(52) U.S. Cl. 493/231

(57) ABSTRACT

A system and method for creating folded flower wraps uses a plurality of molds to define one or more lines in a sheet of material for folding to produce a floral wrap. By sequentially placing each one of the plurality of molds in contact with the sheet of material and folding the sheet of material across each one or more of edges of the molds, the sheet of material is moved from the first position through a plurality of intermediate partially folded positions to the second fully folded position. This second fully folded position corresponds to the desired folded flower wrap. The molds are made from material that is sufficiently rigid to provide for the folding of the flexible sheet of material and can be arranged as a plurality of separate, substantially two dimensional molds or as a single, three dimensional mold having a plurality of separate and distinct mold faces.

### CROSS-REFERENCE TO RELATED APPLICATIONS

The present application is a continuation-in-part application of co-pending and co-owned U.S. patent application Ser. No. 10/687,337 filed Oct. 16, 2003. The entire disclosure of U.S. patent application Ser. No. 10/687,337 is incorporated herein by reference.

### FIELD OF THE INVENTION

This invention relates to materials and methods for wrapping plants and floral arrangements.

### BACKGROUND OF THE INVENTION

Conventional packages for wrapping floral arrangements and flower bunches use one or more sheets of paper or film. To wrap a flower bunch, square or rectangular sheets of the paper or film are folded by hand. Depending on the look the flower packer wants to achieve, the complexity of the folding may vary. More complex arrangements have more folds and require more time and labor to complete. Increased time and labor result in an increased cost of producing folded sheets for wrapping flower bunches. This increased cost can exceed the target cost that customers wish to pay for the flower wraps.

In addition to cost and pricing limitations, the paper and film sheets lack guides or indications showing how to fold the sheets, making it difficult for both manufacturers and end-users to achieve a consistent finished product. One solution to cost and pricing limitations is the flower sleeve. The flower sleeve is a conical shaped bag that is open at the top and at the bottom. Flower sleeves are available in many different sizes to meet the customer's need to properly pack the flowers and floral arrangements of varying size. Also, flower sleeves are produced in conventional bag making machines that make this an easily replicable product. Therefore, consistency from one unit to the other is achieved. Although flower sleeves are convenient and relatively inexpensive to produce, these sleeves lack the hand-wrapped appearance and decorative aspects of a folded sheet.

### SUMMARY OF THE INVENTION

In accordance with the present invention, a sheet of material, for example paper, plastic film or fabric, is pre-folded and pre-glued for the wrapping and packaging of flower bunches and floral bouquets. The sheet of material has a first unfolded position and a second folded position and is moveable from the first position to the second position by folding in a pre-defined sequence along a plurality of lines scored into the sheet of material. The scored lines are arranged to create the pre-defined folding sequence that forms the desired floral packaging or wrapping, preferably having a decorative, hand-wrapped appearance.

The sheet of material can also include visual indicia arranged to illustrate the pre-defined folding sequence and markings arranged to compliment the folded shape of the sheet. A fastening means is provided on at least a portion of the sheet of material to secure the sheet of material in the second folded position. In addition to providing for a single type of packaging, the sheet of material can include a plurality of second folded positions, each one of the plurality of second positions corresponding to a distinct package based upon the folding sequence used when moving the sheet of material from the first position to the second position.

The process can begin by scoring the sheet to mark the fold lines and to make the folding process easy for the person folding the sheet and consistent from one sheet to the next. The sheet of material can be folded by hand or by a machine. Once all folds in the sheet have been made, portions of the sheet which overlap are secured together, for example by gluing, to create the desired floral package. The sheet of material can be shipped folded and secured or can be shipped flat for folding by the end users.

The present invention is also directed to a system and method for creating folded flower wraps using a plurality of molds to define the lines across which the sheet of material is folded and to facilitate folding of the sheet of material across these lines by hand. Each mold can function independent of or in conjunction with the printed and scored lines located on the sheet of material. Suitable patterns for the lines defined by the molds are the same as those provided by the visual indicia on the sheet of material and include a plurality of intersecting lines. In order to facilitate proper alignment and functioning with the visual indicia on the sheet of material, each mold can include visual indicia that correspond to the visual indicia and lines disposed on the sheet of material.

The molds are made from a material that is sufficiently rigid to provide for the folding of the flexible sheet of material and can be arranged as a plurality of separate, substantially two dimensional molds or as a single, three dimensional mold having a plurality of separate and distinct mold faces. Once a mold or mold face is brought into contact with the flexible sheet, the flexible sheet can be folded against one or more of the edges of the mold or mold face.

In order to create the desired folded flower wrap using the plurality of molds or mold faces, a flexible sheet of material is selected, and one or more molds are sequentially placed in contact with at least a portion of the flexible sheet. Once the molds are placed in contact, the sheet of material is folded across each one of the molds to create the desired folded flower wrap. By sequentially placing each one of the plurality of molds in contact with the sheet of material and folding the sheet of material across each one of the molds, the sheet of material is moved from the first unfolded or flat position through a plurality of intermediate partially folded positions to the second fully folded position. This second fully folded position corresponds to the desired folded flower wrap. The fastening means can be applied to one or more areas of the sheet of material to secure the sheet of material in the fully folded position.

When a plurality of substantially two dimensional molds are used, a first substantially two dimensional mold is brought into contact with at least a portion of the flexible sheet of material. The sheet of material is folded across one or more edges of the first mold to a first, partially folded position, and the first mold is removed. A second substantially two dimensional mold is then brought into contact with the sheet of material. The sheet of material is then folded twice across two separate folding edges of the second mold to place the sheet of material in the second fully folded position. The second mold is then removed. If additional folds are needed to achieve the desired flower wrap, then additional molds can be brought into contact with the sheet of material.

When a single substantially three dimensional mold is used, a first face of the substantially three dimensional mold is placed into contact with at least a portion of the flexible sheet of material. The sheet of material is creased along one or more folding edges of the first mold face, and the mold is removed. The sheet of material is then folded along the crease to a partially folded position between the first unfolded and second fully folded positions. A second mold face is then brought into contact with the sheet of material in the first partially folded position, and the sheet of material is creased along one or two edges of the second face. The mold is removed again, and the sheet of material is folded along the creases to the second, fully folded position.

### BRIEF DESCRIPTION OF THE DRAWINGS

In the accompanying drawings that form a part of the specification and are to be read in conjunction therewith and in which like reference numerals are used to indicate like parts in the various views:

FIG. 1 is a plan view of an embodiment of a sheet of material in an unfolded position in accordance with the present invention;

FIG. 2 is a front view of the sheet of material in a folded position holding a floral arrangement;

FIG. 3 is a front view of an embodiment of a sheet of material in a first partially folded position;

FIG. 4 is a front view of an embodiment of a sheet of material in a second partially folded position;

FIG. 5 is a front view of an embodiment of a sheet of material in a folded position;

FIG. 6 is a plan view of an alternative embodiment of a sheet of material in an unfolded position;

FIG. 7 is a perspective view of an embodiment of a first mold in accordance with the present invention;

FIG. 8 is a perspective view of an embodiment of a second mold;

FIG. 9 is a plan view of a sheet of material in contact with the first mold;

FIG. 10 is a plan view of the sheet of material in contact with the second mold;

FIG. 11 is a view of one face of another embodiment of a mold in accordance with the present invention; and

FIG. 12 is a view through line 12-12 of FIG. 11.

### DETAILED DESCRIPTION

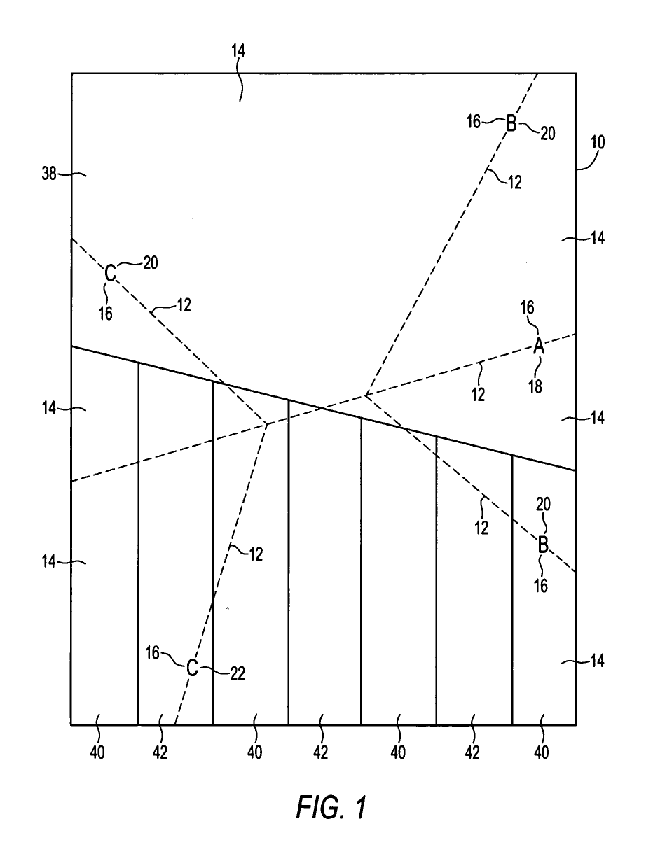

Referring initially to FIG. 1, a sheet of material 10 in accordance with the present invention is illustrated. The sheet of material 10 can be any geometric shaped desired, for example circular, triangular, rectangular and square. In addition to regular geometric shapes, the sheet of material 10 can be arranged as a combination of shapes that create an irregular look. In general, the sheet of material 10 is a substantially two dimensional sheet of material having a thickness of from about 0.1 mils up to about 30 mils, preferably about 0.5 mils up to about 10 mils, more preferably from about 1 mil up to about 5 mils.

Suitable materials for the sheet of material 10 are selected to be generally flexible and foldable. These materials can be arranged as a single layer or as a laminate of two or more layers. Examples of suitable materials include paper, cardboard, metal foils, plastic or polymer films including polypropylene, polyethylene and cellophane films, non-polymer films, fabrics including woven, non-woven, natural and synthetic, fibers, cloths, burlaps and combinations thereof. Preferably, the materials are selected to be suitable for use as packaging or wrapping for flowers, plants and floral arrangements. The sheet of material 10 can be opaque, translucent, transparent and combinations thereof. The opaque, translucent and transparent appearance of the sheet of material 10 can be an inherent quality of the materials from which the sheet is constructed or can be the result of colors, objects, alpha-numeric characters and designs that are printed onto the sheet of material 10.

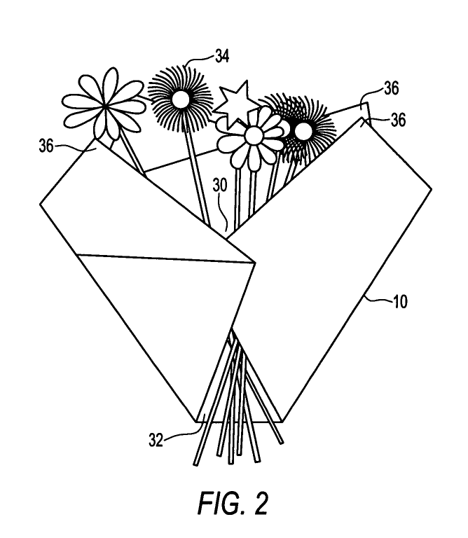

As illustrated in FIG. 1, the sheet of material 10 is in a first, unfolded position wherein the sheet of material 10 is substantially flat. Disposed on either the front or back or both the front and back of the sheet of material 10 are a plurality of intersecting lines 12. The lines 12 divide the sheet of material 10 into a plurality of sections 14. Although the lines 12 can be printed, for example using ink, embossed or etched on the sheet of material 10, preferably the lines 12 are scored in the sheet of material. The lines 12 are arranged to define the lines across which the sheet of material 10 is folded into a second position. In this second position, the sheet of material 10 is fully folded and forms a package, holder or wrapping having a pre-determined shape as shown, for example, in FIG. 2. Preferably, the pre-determined shape is suitable to hold flowers, plants and floral arrangements.

In addition to the location of the fold lines in the sheet of material 10, the sequence of folding the sheet of material 10 across the plurality of lines 12 also contributes to the final appearance and function of the package formed when the sheet of material is moved from the first position to the second position. In one embodiment, the plurality of lines 12 are scored so as to create a pre-defined sequence for folding the sheet of material 10 in order to achieve the desired package shape. Therefore, the scored lines 12 act as creases so that the sheet of material 10 inherently folds across the lines 12 in the proper, pre-determined order or sequence.

In another embodiment, the sheet of material 10 also includes visual indicia 16, for example alpha-numeric indicia, or written instructions disposed adjacent or integrated within the lines 12 and arranged to illustrate the pre-defined folding sequence. The visual indicia 16 can be disposed on either the front or back of the sheet of material 10, and are placed on the sheet of material by any suitable method known in the art including printing, etching and embossing. Preferably, the visual indicia 16 are placed on the sheet of material so that after a first fold has been made across the line having the first visual indicia 18, subsequent indicia are readily viewable. However, the visual indicia 16 do not detract from the final appearance of the package and are preferably hidden from view when the sheet of material 10 is in the second position.

The process for forming the sheet of material 10 into packaging is illustrated in FIGS. 1 and 3-5. The desired appearance of the package constructed from the sheet of material 10 is selected, and the necessary arrangement of lines 12 in the sheet of material and the sequence of folding the sheet of material 10 across the lines 12 are determined. Next, the plurality of intersecting lines 12 is scored in the sheet of material 10 in accordance with the pre-determined arrangement. The method of scoring the lines 12 varies depending on the type material used. In one embodiment, a die is used to apply the scoring via pressure. In another embodiment, the sheet of material 10 is constructed of paper, and a plurality of sheets of paper are simultaneously scored with the desired arrangement of lines. In yet another embodiment, the sheet of material 10 is constructed from a film material, for example a polymer film, and a single film sheet is scored using a metallic die. Other methods for scoring the plurality of lines 12 in the selected sheet of material 10 are available as would be understood by one of skill in the art.

After scoring, the folding angle is defined, thus allowing the operator to easily fold the sheets using the scores on the sheet as guides. The plurality of lines 12 can also be printed on the sheet of material 10, and, if desired, the visual folding sequence indicia 16 are added or printed on the sheet of material 10.

The sheet of material 10 is then folded in the sequence defined by the plurality of scored lines 12 and illustrated by the visual indicia 16. Alternatively, the sheet of material 10 can be folded, either by hand or by a machine, without first scoring the plurality of lines 12 in the sheet of material. In this embodiment, the machine would fold a completely flat and non-scored sheet of material 10 in the proper sequence to form the pre-determined package shape. In either embodiment, the same sequence and arrangement for folding can be used to produce the same pre-determined packages.

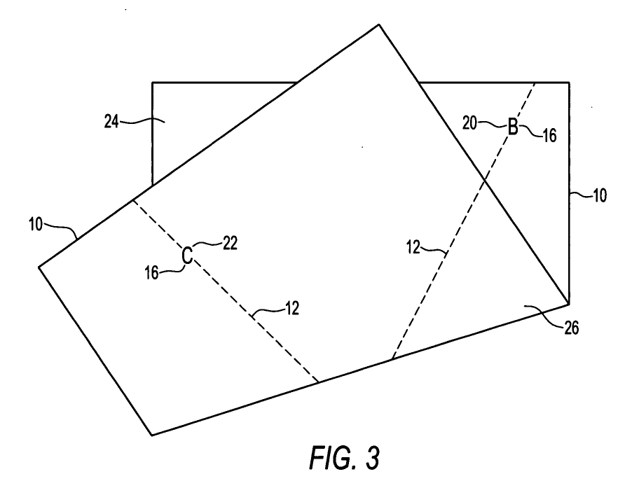

As shown in FIG. 3, the sheet of material 10 is folded across the scored line containing the first visual indicia 18. Once folded, the second visual indicia 20 are visible. If in addition to being scored, the lines are also printed, the printed lines running along the scored lines and containing the second visual indicia 20 are also visible. In one embodiment, the printed lines 12 are visible because the lines are printed on the front 24 of the sheet of material 10, and the sheet of material 10 is transparent or translucent. Alternatively, the lines 12 are printed on both the front 24 and the back 26 of the sheet of material 10. Since the lines 12 can actually be scored into the sheet of material 10 so as to indicate both the location of the lines and sequence of folding, printing of the lines 12 or alpha-numeric indicia 16 is optional.

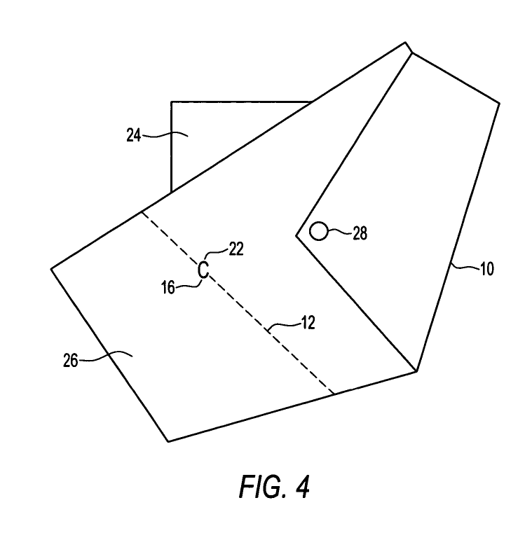

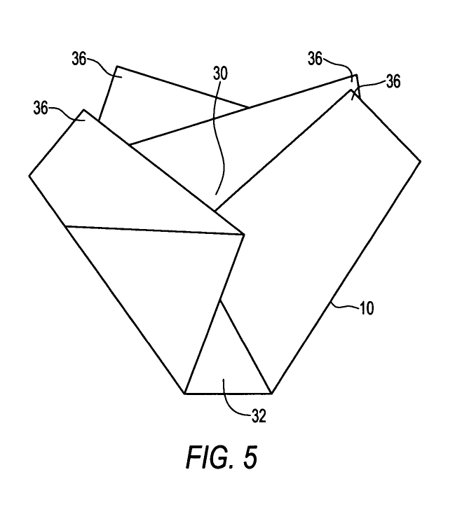

As shown in FIG. 4, the sheet of material is folded across the scored line 12 containing the second visual indicia 20. Once folded, the next or third visual indicia 22 are visible. Next, the sheet of material 10 is folded across the line 12 containing the third visual indicia 22 to create the pre-determined package illustrated in FIG. 5. Although five intersecting fold lines defining a three-step folding sequence are illustrated, the number of fold lines is not limited to five but is determined by the desired final shape of the package.

The sheet of material 10 is then secured in the pre-determined package shape. As shown in FIG. 4, the sheet of material is secured in the pre-determined shape by applying a fastening means 28 to at least one portion or location on the flexible sheet of material 10. Alternatively, the fastening means is applied to a plurality of locations across the sheet of material. Preferably, the portions of the sheet of material 10 containing the fastening means 28 overlap when the sheet of material is in the second, folded position. Any fastening means capable of bonding one location on the sheet of material to another can be used. The fastening means can fixedly or releasably secure the sheet of material in the pre-determined shape. Suitable fastening means include adhesives, double-sided tape, mechanical fasteners, direct bonds and combinations thereof. Once the sheet of material has been scored, folded and secured, the particular place where the scoring has been made will prevent the material from loosing the defined fold. In other words, the fold will stay in place.

Once folded and secured, the package is then shipped to the end user. This method facilitates the efficient manufacture of a consistent package for holding flowers, floral arrangements and plants. In an alternative embodiment, the sheet of material 10 can be shipped to the end user as a flat, scored sheet before folding and securing. Since the sheet of material is scored, the end user can easily and consistently fold the sheet into the desired package shape. In this embodiment, the fastening means 28 is applied to the sheet of material 10 in the proper location. A preferred fastening means in this embodiment is double-sided tape.

As illustrated in FIG. 5, the predetermined shape in one embodiment is generally conical having an open top 30 and bottom 32 and a plurality of peaked or pointed sections 36. This facilitates the placement of floral arrangements 14 in the package (FIG. 2). Although illustrated as a conical flower wrap, other package shapes are possible. In one embodiment, the pre-determined shape has the appearance of being wrapped by hand. In another embodiment, the pre-determined shape has the appearance of multiple overlapping layers of wrap.

The pre-determined shape can be enhanced by using an arrangement of markings disposed across the sheet of material 10 and arranged to produce a selected appearance when the sheet is in the second position. In one embodiment, this selected appearance is arranged to compliment the folded shape of the sheet of material 10. Suitable markings include arrangements of opaque, translucent and transparent areas. These areas can be an inherent quality of the sheet of material 10 or can be printed or otherwise placed on the sheet of material 10. The markings can be uniform or can vary across the entire sheet of material 10. In addition, the markings can correspond to the plurality of lines 12. For example, the markings can vary among the various sections 14 defined by the lines 12. In one embodiment as shown in FIG. 1, the markings include a portion containing a first translucent color 38 and a portion containing transparent areas 40 and areas having a second translucent color 42. In general, the markings are selected based upon the desired final appearance of the package. For example, in a conical package embodiment, the markings can be selected to produce a generally conical shaped package having the appearance of a generally translucent, colored inner wrap surrounded by a generally transparent outer wrap.

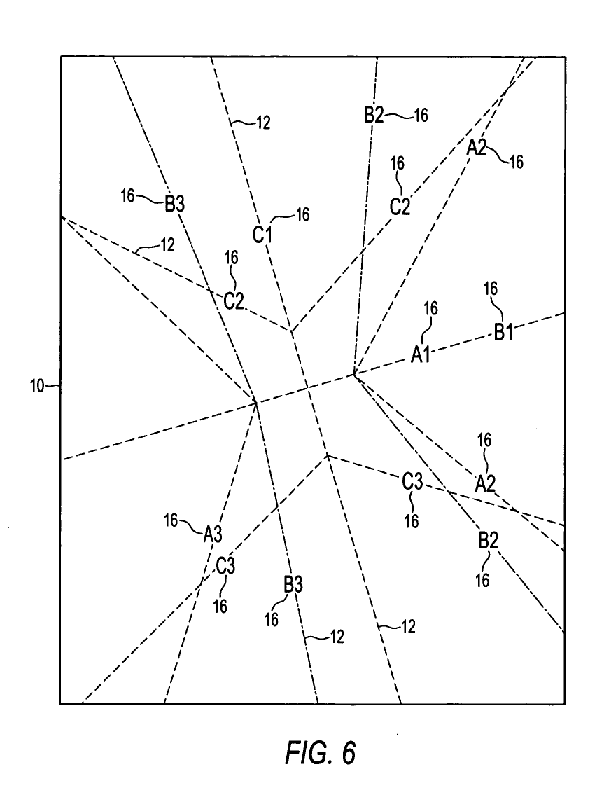

In another embodiment of the present invention as illustrated in FIG. 6, a single sheet of material can be arranged to have a plurality of second positions. Each second position corresponds to a distinct package. The plurality of lines 12 are arranged to define each one of the distinct packages based upon the folding sequence used when moving the sheet of material 10 from the first position to the second position. In order to make a sheet of material 10 in accordance with this embodiment, a plurality of lines 12 defining a plurality of distinct folding sequences are scored into the sheet of material. The desired package and associated folding sequence is then selected, and the sheet of material 10 is folded in accordance with the selected folding sequence. Distinct printed lines and visual alpha-numeric indicia 16 can be applied to the sheet of material to indicate the proper groupings and folding sequences of lines, for example A1-A3, B1-B3 and C1-C3. In addition, the indicia 16 can indicate the final package shape for a given selection of lines 12.

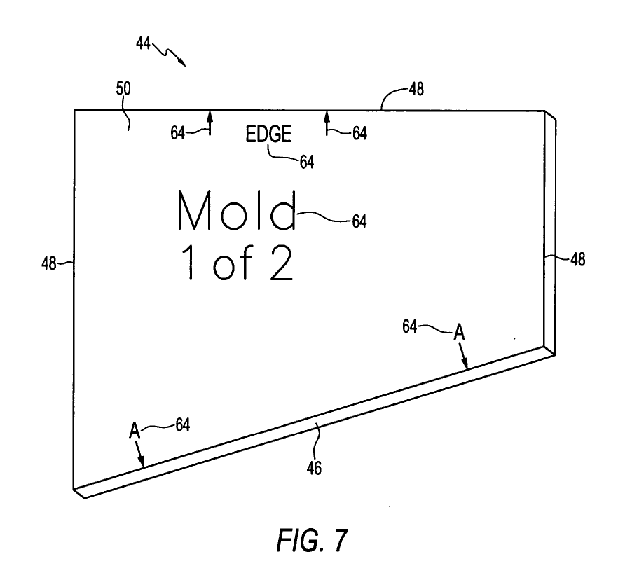

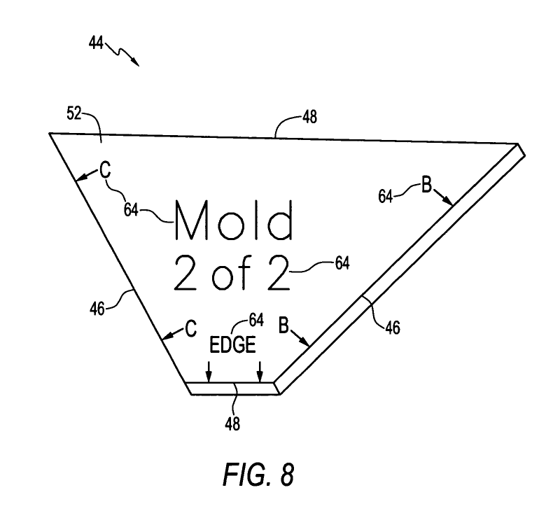

The present invention is also directed to a system and method for creating and making the folded flower wraps of the present invention either by hand or using an automated production line. In one embodiment as illustrated in FIGS. 7 and 8, the system uses one or more molds 44 to provide for the folding of each flexible sheet of material 10 from the first unfolded position to the second folded position corresponding to the desired flower wrap shape. Each mold 44 is arranged to cover at least a portion of the sheet of material 10 and to define one or more lines to fold the sheet of material 10 across. Suitable arrangements for the lines defined by the mold correspond to the plurality of intersecting lines 12 that divide the sheet of material 10 into a plurality of sections 14 and are printed or scored into the sheet of material 10.

In order to define the fold lines, each mold 44 includes one or more folding edges 46. The folding edges 46 are arranged to be the edges across which the sheet of material is folded. Each mold 44 may also contain one or more additional edges 48. The additional edges 48 can be arranged to provide for the desired alignment between the mold 44 and the sheet of material 10, for storage or stacking with the other molds or for aesthetic purposes. For example, one or more of the additional edges can be arranged to be aligned with edges in the sheet of material 10, with the lines 12 printed or scored into the sheet of material 10, or with both edges and lines 12.

The molds 44 are arranged to provide for not only the desired location of the fold lines in order to create the pre-determined floral wrap shape but also the desired folding sequence. Therefore, by placing each one of the plurality of molds 44 into contact with the sheet of material 10 in accordance with the prescribed sequence and folding the sheet of material 10 across one or more folding edges 46 on each one of the molds 44, the sheet of material 10 is moved from the first position to the second position.

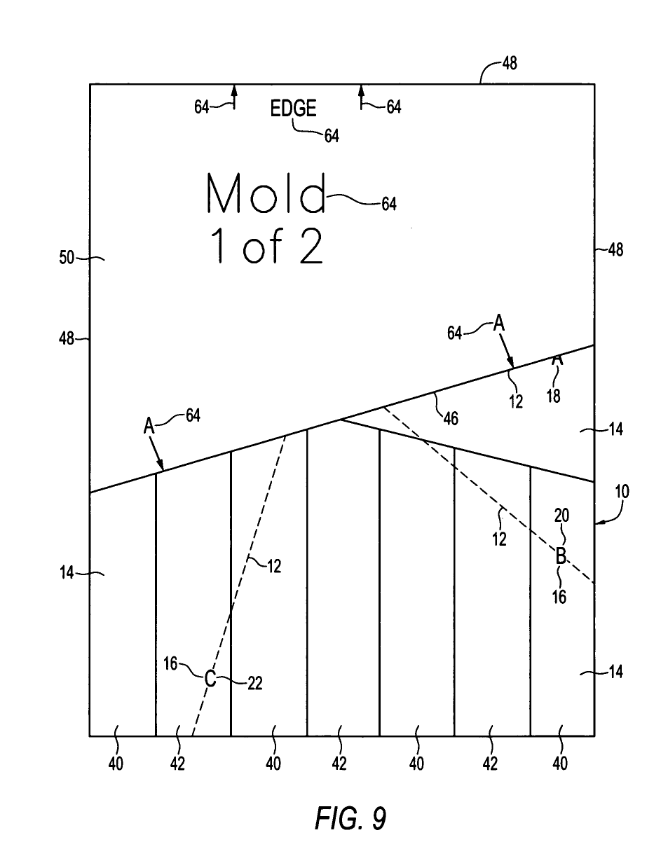

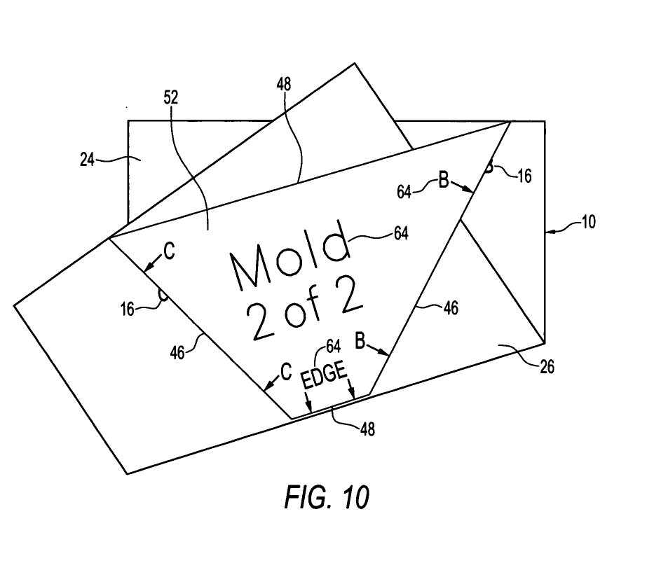

In the embodiment illustrated in FIGS. 7 and 8, the system includes a first mold 50 that is arranged to be brought into contact with the sheet of material 10 in the first unfolded or flat position (FIG. 9). The sheet of material 10 can then be moved to a partially folded position (FIG. 3) between first and second positions by folding across at least one folding edge 46 of the first mold 50. The second mold 52 is arranged to be aligned with and brought into contact with the sheet of material 10 when the sheet of material is in the partially folded position (FIG. 10). The sheet of material 10 can then be moved to the second, folded position (FIG. 5) by folding across two folding edges 46 of the second mold 52. Although illustrated with two molds 44 and at least one partial or intermediate folded position between the first and second positions, the system of the present invention can employ more than two molds 44. The number of molds 44 depends upon the desired appearance of the flower wrap and the folding sequence necessary to create the desired flower wrap from a flat sheet of material 10. As more molds 44 are used, the number of partially folded positions will increase accordingly, resulting in a plurality of partially folded positions corresponding to the number of required folds.

In one embodiment as illustrated in FIGS. 7 and 8, each mold 44 is constructed from a substantially two-dimensional material. In general, the material is sufficiently rigid to provide for the folding of the sheet of material 10. That is, the mold 44 does not bend or flex substantially when the sheet of material 10 is folded across it and provides for a sufficiently well defined folding line. Suitable materials include cardboard, paper, wood, plastic, metal, glass, laminated materials and combinations thereof. The thickness of the mold 44 is selected to be no more than is needed to provide for the necessary rigidity given the type of material. Preferably, the material is as thin as possible to allow the sheet of material to be folded as far as possible with the mold 44 in place against the sheet of material 10. Therefore, materials that provide for maximum rigidity with a minimum thickness are preferred. The folding edges 46 may also be tapered to provide for a more complete fold.

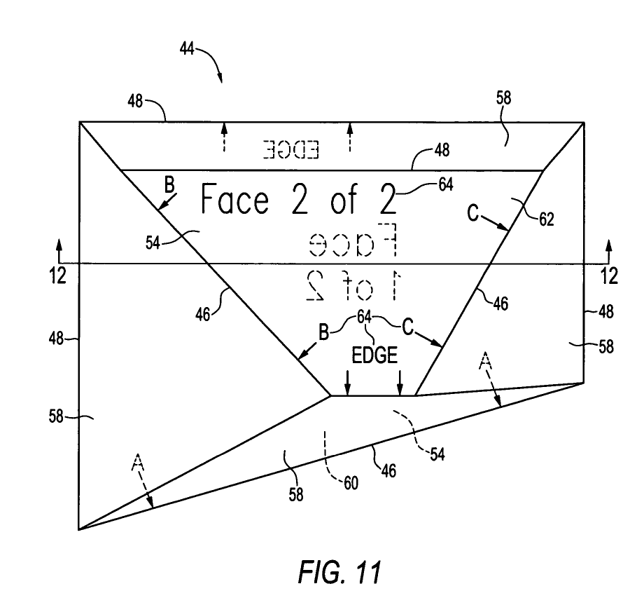

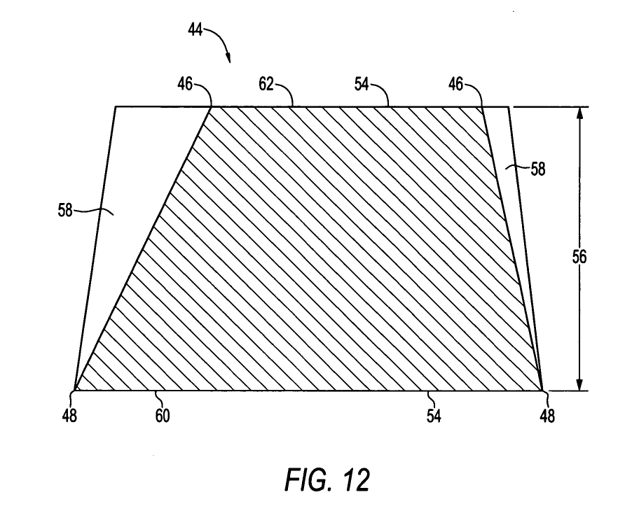

In another embodiment as illustrated in FIGS. 11 and 12, each mold 44 can be constructed as a substantially three dimensional object. Suitable materials for the three dimensional object include cardboard, paper, wood, plastic, metal, glass and combinations thereof. Instead of using a plurality of separate molds 44 to define the sequence and arrangement of folds, the three dimensional embodiment has a plurality of mold faces 54. In the embodiment illustrated, the mold 44 includes two mold faces 54 arranged to cover a portion of the sheet of material 10 and to define the lines to fold the sheet of material across. As shown in FIG. 12, these two faces are separated by a distance 56. The mold 44 also includes additional faces 58 as dictated and needed by the three dimensional arrangement of the mold faces 54. In addition, more than two mold faces 54 can be provided.

In the embodiment illustrated in FIGS. 11 and 12, the mold 44 includes two mold faces 54, a first mold face 60 and a second mold face 62. These mold faces 54, as illustrated, provide functionality similar to the first and second molds 50,52 illustrated above. The first and second mold faces 60,62 include folding edges 46 to define one or more lines to fold the sheet of material 10 across. The sheet of material 10, however, may not be able to be completely folded with the three dimensional mold 44 in place. Therefore, the sheet of material 10 is preferably creased along one or more of the folding edges 46 of the mold faces 54, and then the mold 44 is removed to facilitate complete folding of the sheet of material 10 along the creases.

In one embodiment, multiple flower wraps can be generated from a single set of two dimensional molds 44 or a single three dimensional mold 44 having two or more mold faces 54. When a set of a plurality of two dimensional molds is used, the final appearance of the flower wrap is determined by the number and type of molds used, the sequence of using the molds and the folding edges of each mold that are used. For a single three dimensional mold 44 containing a plurality of distinct mold faces 54, the final appearance of the flower wrap is dictated by the number and type of mold faces 54 used, the sequence with which the selected mold faces 54 are brought into contact with the sheet of material 10 and the folding edges 46 of each mold face that are used.

In one embodiment each mold 44, including both the two dimensional and three dimensional embodiments, contains visual indicia 64 corresponding to the arrangement of the visual indicia 16 on the sheet of material 10, for example the lines and alpha-numeric indicia. The corresponding visual indicia 64 on the molds 44 are arranged to indicate the folding sequence, to facilitate proper alignment of each mold with the flexible sheet of material, to indicate the groupings of the various molds 44 or faces 54 and to indicate the sequence of using the molds 44 or faces 54 within a given grouping. The visual indicia 64 can be placed on the mold 44 or face 54 by any suitable process including printing, etching and embossing.

In an embodiment of a method for creating folded flower wraps using the mold system in accordance with the present invention, the desired appearance of the folded floral wrap is determined, and a flexible sheet of material to be folded into the desired flower wrap is selected. One or more molds are then placed in contact with at least a portion of the flexible sheet, and the sheet of material is folded across each one of the molds to create the desired folded flower wrap. When two or more molds are used, each mold is placed in contact with the flexible sheet in a sequence corresponding to the predetermined final appearance of the folded flower wrap.

In one embodiment, in order to place the molds 44 in contact with the sheet of material 10 and to fold the sheet of material across the molds, a first, substantially two dimensional mold is brought into contact with at least a portion of the flexible sheet of material when the sheet of material is in the unfolded position. The sheet of material is then folded across one or more edges of the first mold to a first partially folded position. Once folded, the first mold is removed. A second mold is then brought into contact with at least a portion of the sheet of material while the sheet of material is in the first partially folded position. The sheet of material is then folded across one edge of the second mold from the first partially folded position to a second partially folded position. The sheet of material is then folded again across the second mold from the second partially folded position to the second, folded position. The second mold is then removed, and, if desired, the sheet of material is secured in the second position using the fastening means. Additional molds can be brought into contact with the sheet of material depending upon the desired appearance of the folded flower wrap and the number of folds required.

In another embodiment of placing the molds in contact with the flexible sheet of material and folding the sheet of material, a first face of a substantially three dimensional mold is brought into contact with at least a portion of the flexible sheet of material when the sheet of material is in a first unfolded position. The sheet of material is then creased along an edge of the first face, and the mold is removed. Once removed, the sheet of material is folded along the crease to place the sheet of material in a first partially folded position. With the sheet of material in the first partially folded position, a second face of the mold is brought into contact with the sheet of material, and the sheet of material is creased along two edges of the second face. The mold is removed again, and the sheet of material is folded along the two creases into the second, fully folded position.

In another embodiment of the method, visual indicia, for example lines and alpha-numeric indicia, are placed on the flexible sheet of material to indicate the folding sequence and to facilitate proper alignment of each mold with the flexible sheet of material. Each two dimensional mold or each face of the three dimensional mold is aligned with the visual indicia when placing the molds in contact with the flexible sheet of material. In one embodiment, corresponding visual indicia are placed on one or more of the two dimensional molds or on one or more faces of the three dimensional mold.

The present invention uses the systems and methods to facilitate assembly of the flower containers and wraps either by hand or using a machine. Using the sheets, molds and methods in accordance with the present invention, a large number of flower wraps can be produced having substantially the same appearance. The present invention facilitates the production of the floral wrap in a timely fashion. For example, when a customer places an order, an expected delivery date is specified. The expected delivery date in many cases is set by the flora holiday, for example Valentines Day. The flower packer will not have enough time to purchase flat sheets and fold them into wraps. Therefore, the flower packer needs the wraps provided folded. Moreover, if the wraps are not delivered to the bouquet packers prior to the designated holiday, the opportunity to sell these wraps will have lapsed at least for one year and possibly completely lost. If one would try to make all these wraps by hand with no scoring, then it would greatly hinder production efficiency. In addition, the present invention resolves the technical problem of being able to produce these at a reasonable and comparable cost to producing a flower sleeve.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A system for creating folded flower wraps, the system comprising:
a flexible sheet of material, the sheet of material capable of being positioned in a first unfolded position and a second folded position corresponding to the folded flower wrap; and
a plurality of molds, each mold arranged to cover a portion of the sheet of material and to define one or more lines to fold the sheet of material across;
wherein by sequentially placing one or more of the plurality of molds in contact with the sheet of material and folding the sheet of material across each one of the molds, the sheet of material is moved from the first position to the second position.

2. The system of claim 1, wherein the sheet of material comprises at least one partially folded position between the first and second folded positions and the plurality of molds comprises:
a first mold arranged to be brought into contact with the sheet of material in the first unfolded position, the sheet of material moved to the partially folded position by folding across the first mold; and
a second mold arranged to be brought into contact with the sheet of material in the partially folded position, the sheet of material moved to the second folded position by folding across the second mold.

3. The system of claim 1, wherein each mold comprises a substantially two dimensional material.

4. The system of claim 1, wherein each mold comprises at least two edges across which the flexible sheet of material can be folded.

5. The system of claim 1, wherein each mold comprises cardboard, paper, wood, plastic, metal, glass or combinations thereof.

6. The system of claim 1, wherein each mold comprises a substantially three dimensional object having a plurality of faces, wherein two or more of the faces are arranged to cover the portion of the sheet of material and to define the lines to fold the sheet of material across

7. The system of claim 1, wherein the flexible sheet of material comprises an arrangement of visual indicia arranged to indicate the folding sequence and to facilitate proper alignment of each mold with the flexible sheet of material.

8. The system of claim 7, wherein the visual indicia comprise alpha-numeric indicia and lines.

9. The system of claim 8, wherein the lines comprise a plurality of intersecting lines.

10. The system of claim 8, wherein each mold comprises corresponding visual indicia.

11. The system of claim 1, further comprising a fastening means disposed on a least a portion of the sheet of material to secure the sheet of material in the second folded position.

12. A method for creating folded flower wraps, the method comprising:
selecting a flexible sheet of material to be folded into a flower wrap;
placing one or more molds in contact with at least a portion of the flexible sheet; and
folding the sheet of material across each one of the molds to create the folded flower wrap.

13. The method of claim 12, wherein the steps of placing the molds in contact with the flexible sheet of material and folding the sheet of material comprise:
placing a first substantially two dimensional mold into contact with at least a portion of the flexible sheet of material when the sheet of material is in the unfolded position;
folding the sheet of material across the first mold to a first partially folded position;
removing the first mold;
placing a second substantially two dimensional mold into contact with the sheet of material in the first partially folded position;
folding the sheet of material across the second mold to a second partially folded position;
folding the sheet of material across the second mold a second time to a fully folded position; and
removing the second mold.

14. The method of 12, wherein the steps of placing the molds in contact with the flexible sheet of material and folding the sheet of material comprise:
placing a first face of a substantially three dimensional mold into contact with at least a portion of the flexible sheet of material when the sheet of material is in a first unfolded position;
creasing the sheet of material along an edge of the first face;
removing the mold;
folding the sheet of material along the crease to a first partially folded position;
placing a second face of the mold into contact with the sheet of material in the first partially folded position;
creasing the sheet of material along two edges of the second face;
removing the mold; and
folding the sheet of material along the two creases to a fully folded position.

15. The method of claim 12, further comprising placing visual indicia on the sheet of material to indicate the folding sequence and to facilitate proper alignment of each mold with the flexible sheet of material.

16. The method of claim 15, further comprising aligning the molds with the visual indicia when placing the molds in contact with the flexible sheet of material.

17. The method of claim 15, further comprising placing corresponding visual indicia on one or more of the plurality of molds.
